(19) United States
(12) Patent Application Publication
(10) Pub. No.: US 2022/0389202 A1
(43) Pub. Date: Dec. 8, 2022

(54) FORTREX ADDITIVE FOR LOW ROLLING RESISTANCE TIRES

(71) Applicant: Cooper-Standard Automotive, Inc.,, Northville, MI (US)

(72) Inventors: Krishnamachari GOPALAN, Troy, MI (US); Robert LENHART, Fort Wayne, IN (US)

(21) Appl. No.: 17/834,454

(22) Filed: Jun. 7, 2022

Related U.S. Application Data
(60) Provisional application No. 63/208,349, filed on Jun. 8, 2021.

(51) Int. Cl. C08L 15/00; C08J 3/22; B60C 1/00

(52) U.S. Cl. CPC C08L 15/00; C08J 3/226; B60C 1/0016; C08L 2310/00; C08L 2205/025; C08L 2205/035; C08L 2312/08

(57) ABSTRACT

A tread additive composition to be combined with a base composition for tire treads to achieve low rolling resistance includes an elastomeric component, a first additive component, and a second additive component. The elastomeric component includes a first silane-grafted polyolefine elastomer. The first additive component including a polymer carrier, a reinforcing filler, silane-terminated liquid polybutadienes, and one or more process activators. The second additive component including a butadiene rubber, a hydrocarbon resin, sulfur; and one or more accelerators. Advantageously, the tread additive composition can decrease rolling resistance and improve fuel economy when combined with a base tread composition as compared to treads formed from the base tread composition without the tread additive composition.

### CROSS-REFERENCE TO RELATED APPLICATIONS

This application claims the benefit of U.S. provisional application Ser. No. 63/208,349 filed Jun. 8, 2021, the disclosure of which is hereby incorporated in its entirety by reference herein.

### TECHNICAL FIELD

In at least one aspect, compositions and additive for making tire treads are provided.

### BACKGROUND

Current state of the art tire tread compounds can offer good abrasion and low rolling resistance but guidelines to improve fuel economy and reduce emissions continue to be very challenging. Existing tire treads are typically made from sulfur cured blends of butadiene rubber, styrene butadiene rubber, and other polymers such as natural rubber. These polymers, along with other additives, can provide good handling and abrasion resistance along with low rolling resistance. However, demand for higher treadwear resistance and higher fuel economy continue to grow. In addition, the new electric vehicles demand higher mileage per charge, higher wear resistance and reduced stopping distance.

Accordingly, there is a need for tread compositions that allow for lower rolling resistance with improved fuel economy.

### SUMMARY

In at least one aspect, a tread additive composition to be combined with a base composition for tire treads or tank track pads to achieve low rolling resistance is provided. The tread additive composition includes an elastomeric component, a first additive component, and a second additive component. The elastomeric component includes a first silane-grafted polyolefin elastomer and/or silane-grafted styrene-ethylene-butylene-styrene elastomer. The reinforcing component including a polymer carrier, a reinforcing filler, silane-terminated liquid polybutadienes, and one or more process activators. The second additive component including a butadiene rubber, a hydrocarbon resin, sulfur; and one or more accelerators. Advantageously, the tread additive composition can decrease rolling resistance, improve fuel economy and improved abrasion resistance for extended tire life when combined with a base composition for tire treads as compared to treads formed from the base composition for tire treads without the tread additive composition.

In another aspect, a tire tread composition for forming tire treads or tank track pads includes the tread additive composition set forth herein and a base composition for tire treads.

In another aspect, a tire tread is fabricated by forming the tire tread composition of into tire treads and then curing the tread composition. The tire tread composition for forming tire treads includes the tread additive composition set forth herein and a base composition for tire treads.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic illustration of a pneumatic tire having a tread block made with a tread additive composition that improves rolling resistance.

FIG. 2A. Bar chart showing the results of resilience testing.

FIG. 2B. Bar chart showing the results of Goodrich Heat build-up experiments.

FIG. 3. Bar chart showing aging results after aging at 100° C. for 72 hrs.

FIG. 4. Spider graph summarizing the comparison between Examples 1-4 with base composition 1.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alkylaryl (e.g., C₁₋₈ alkyl C₆₋₁₀ aryl), —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃″M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

Throughout this application, where publications are referenced, the disclosures of these publications in their entireties are hereby incorporated by reference into this application to more fully describe the state of the art to which this invention pertains.

Abbreviations:

“SSBR” means solution styrene-butadiene rubber.

“phr” means parts per 100 parts by weight of rubber.

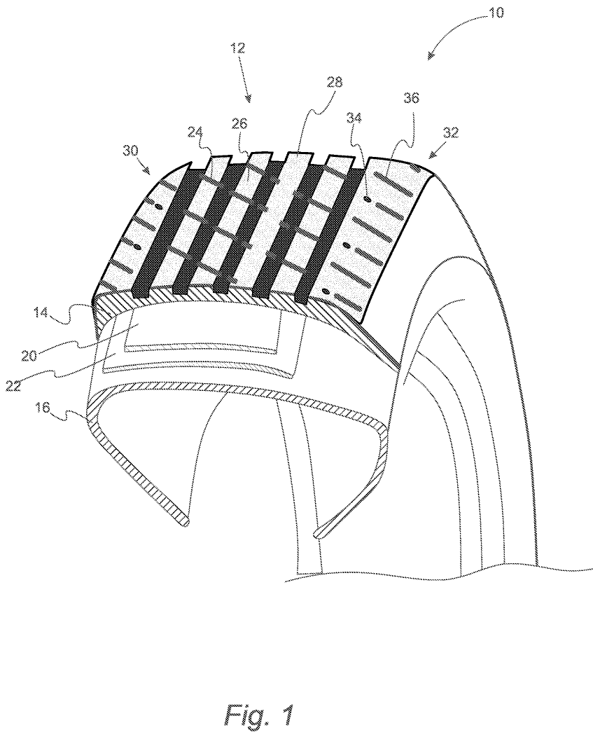

FIG. 1 provides a schematic illustration of a pneumatic tire having a tread section that is formed from a thread composition with improved rolling resistance. Pneumatic tire 10 includes tread block 12 disposed over undertread 14, which is disposed over carcass 16. Cap piles 20 and belts 22 are interposed between the undertread 14 and carcass 16. Sidewall 22, which abuts thread block 12, is also depicted. The additives and compositions set forth herein are used for forming tread section 14.

Tread block 12 includes treads 24 defined by the tread rubber and interposed between blocks 26. Tread block 12 can also include ribs 28, which is a pattern of tread features aligned around the circumference of the tire. Tread block12 also includes shoulder sections 30 and 32 which have dimples 34 and sipes 36 defined by the tread rubber therein.

In one aspect, a tread additive composition to be combined with a base composition fore tire treads or tank track pads to achieve low rolling resistance is provided. A typical base (standard) composition for tire treads includes synthetic rubbers, natural rubbers, sulfur and various fillers. Examples of synthetic rubbers include polybutadiene rubbers and styrene-butadiene rubbers. In a refinement, the base composition is a tread composition that a tire manufacturers typically uses for making treads. The tread additive composition set forth herein includes an elastomeric component, a first additive component, and a second additive component. The elastomeric component provides the improvement in rolling resistance achieved with the tread additive composition. The first additive component provides mechanical strength and processability to the elastomeric component. The second additive component provides the component necessary for crosslinking and curing the elastomeric additive composition. Advantageously, the tread additive composition can decrease rolling resistance, improve fuel economy and improved abrasion resistance for extended tire life when combined with a base composition for tire treads as compared to treads formed from the base composition for tire treads without the tread additive composition.

In a variation, a complete base composition for tire treads (“base (standard) tread composition”) includes from about 30 to 63 weight percent of the base (standard) tread composition and about 70 to 37 weight percent of the tread additive composition. In particular, a complete tread composition includes from about 35 to 55 weight percent of the base tread composition and about 45 to 30 weight percent of the elastomeric component, 15 to 5 weight percent of the first additive component, and 10 to 2 weight percent of the second additive component.

In a variation, the elastomeric component includes a first silane-grafted polyolefin elastomer and/or silane-grafted styrene-ethylene-butylene-styrene elastomer (e.g, silane grafted hydrogenated styrene-ethylene-butylene-styrene elastomer). The first silane-grafted polyolefin is formed from a elastomeric component reaction blend that includes a first polyolefin and a silane crosslinker. In some variations, the elastomeric component reaction blend is reacted in a reactive extrusion reactor to form the elastomeric component. In a refinement, the elastomeric component is pelletized after extrusion. In a refinement, the elastomeric component reaction blend further includes a first peroxide initiator. In a particularly useful formulation, the first silane-grafted polyolefin elastomer is an olefin block copolymer. In a refinement, the olefin block copolymer has a density less than about 0.9 g/cm³. Typically, the density is greater than about 0.8 g/cm³. In a refinement, the olefin block copolymer has a first melt index less than about 5. Typically, the silane crosslinker of the elastomeric component reaction blend has the following formula:

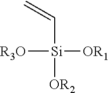

wherein R₁, R₂, and R₃ are each independently H or C₁₋₈ alkyl. In a further refinement, R₁, R₂, and R₃ are each methyl, ethyl, propyl, or butyl. In another refinement, the elastomeric component reaction blend includes at least one additional silane-grafted polyolefin elastomer.

In some variations, the elastomeric component has a glass transition temperature less than −30° C. Therefore, a complete tread composition is blended with the base tire composition to achieve a glass transition temperature greater than −20° C., e.g., −20 to 0° C. Glass transition temperature greater than −20° C. are needed in order to improve the wet traction for the tires at ambient temperatures greater than about 10° C. In a refinement, the elastomeric component has a compression set of from about 5.0% to about 35.0%, as measured according to ASTM D 395 (22 hrs @80° C.).

In a variation, the first additive component includes a polymer carrier, a reinforcing filler, silane-terminated liquid polybutadienes, and one or more process activators. A useful reinforcing filler is silica. Examples of process activators include but are not limited to stearic acid, polyethylene glycol, and combinations thereof. In a refinement, the polymer carrier is an ethylene vinyl acetate or an ethylene vinyl acetate copolymer. Typically, the ethylene vinyl acetate copolymer has a vinyl acetate content from about 10 to 50 mole percent. In a refinement, the ethylene vinyl acetate copolymer has a vinyl acetate content of at least 5 mole percent, 10 mole percent, 15 mole percent, 20 mole percent, or 25 mole percent. In a further refinement, ethylene vinyl acetate copolymer has a vinyl acetate content of at most 60 mole percent, 50 mole percent, 40 mole percent, 35 mole percent, or 30 mole percent.

In a variation, the second additive component includes a butadiene rubber, a hydrocarbon resin, an optional second peroxide, sulfur, and one or more accelerators for sulfur crosslinking. Examples of process accelerators include but are not limited to N-cyclohexyl-2-benzothioazole sulfenamide and diphenyl guanidine.

In some variations, the tread additive composition allows for a dual curing system. In this instance, the sulfur formed sulfur bridges within the polymer in the base composition. The presence of peroxide forms carbon-carbon bonds in the polymers in the tread additive composition and in the polymer in the base composition.

In some variations of the tread composition, the first silane-grafted polyolefin elastomer is present in an amount from about 40 to 85 weight percent of the total weight of the tread additive composition; the linear, non-reactive polydimethylsiloxane is present in an amount from about 0.005 to 0.3 weight percent of the total weight of the tread additive composition; the polymer carrier is present in an amount from about 5 to 20 weight percent of the total weight of the tread additive composition; the reinforcing filler is present in an amount from about 1 to 10 weight percent of the total weight of the tread additive composition; the silane-terminated liquid polybutadienes is present in an amount from about 1 to 7 weight percent of the total weight of the tread additive composition; the butadiene rubber is present in an amount from about 2 to 15 weight percent of the total weight of the tread additive composition; and sulfur is present in in an amount from about 0.1 to 2 weight percent of the total weight of the tread additive composition. In a further refinement, the antioxidant is present in an amount from about 0.001 to 0.3 weight percent of the total weight of the tread additive composition. In still a further refinement, the one or more process activators are present in an amount from about 0.01 to 2 weight percent of the total weight of the tread additive composition. In still a further refinement, the one or more accelerator in an amount from about 0.1 to 2 weight percent of the total weight of the tread additive composition. In yet a further refinement, the first peroxide initiator is present in an amount from about 0.005 to 0.3 weight percent of the total weight of the tread additive composition and the second peroxide initiator is present in an amount from about 0.5 to 7 weight percent of the total weight of the tread additive composition.

In a variation, the first silane-grafted polyolefin elastomer and/or the at least one additional silane-grafted polyolefin elastomer is selected from the group consisting of silane-grafted ethylene/α-olefin copolymers silane-grafted olefin block copolymers, and combinations thereof.

In other refinements, the first silane-grafted polyolefin elastomer and/or the at least one additional silane-grafted polyolefin elastomer is selected from the group consisting of silane-grafted homopolymers, silane-grafted blends of homopolymers, silane-grafted copolymers of two or more olefins, silane-grafted blends of copolymers of two or more olefins, and a combination of olefin homopolymers blended with copolymers of two or more olefins.

In still other refinements, the first silane-grafted polyolefin elastomer and/or the at least one additional silane-grafted polyolefin elastomer are each independently a silane-grafted homopolymer or silane-grafted copolymer of an olefin selected from the group consisting of ethylene, propylene, 1-butene, 1-propene, 1-hexene, 1-octene, C₉₋₁₆ olefins, and combinations thereof.

In another refinement, the first silane-grafted polyolefin elastomer and/or the at least one additional silane-grafted polyolefin elastomer each independently include a silane-grafted polymer selected from the group consisting of silane-grafted block copolymers, silane-grafted ethylene propylene diene monomer polymers, silane-grafted ethylene octene copolymers, silane-grafted ethylene butene copolymers, silane-grafted ethylene α-olefin copolymers, silane-grafted 1-butene polymer with ethene, silane-grafted polypropylene homopolymers, silane-grafted methacrylate-butadiene-styrene polymers, silane-grafted polymers with isotactic propylene units with random ethylene distribution, silane-grafted styrenic block copolymers, silane-grafted styrene ethylene butylene styrene copolymer, and combinations thereof.

As set forth above, the tread additive composition can include a first peroxide initiator and a second peroxide initiator. In a refinement, the first and second peroxide initiators can independently include a peroxide selected from the group consisting of hydrogen peroxide and organoperoxides such as alkyl hydroperoxides, dialkyl peroxides, and diacyl peroxides. Examples for the peroxide include, but are not limited to, an organic peroxide selected from the group consisting of di-t-butyl peroxide, t-butyl cumyl peroxide, dicumyl peroxide, 2,5-dimethyl-2,5-di(t-butyl-peroxy)hexyne-3,1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, 2,5-Dimethyl-2,5-di-(tert-butylperoxy)-hexane, 2,5-bis(t-butylperoxy)-2,5-dimethyl-3-hexyne, 2,4-dichlorobenzoyl peroxide, and combinations thereof.

In another embodiment, a tread composition includes polybutadiene rubber, natural rubber, solution styrene-butadiene rubber, sulfur coupling agent and a plurality of additives. An example of a coupling agent is bis(triethoxysilylpropyl) polysulfide. The additive are selected from the group consisting of reinforcing fillers such as silica, carbon black, plasticizer, activators, accelerators, antiozonants, and combinations thereof. Examples of activators includes stearic acid and zinc oxide. An example of an antiozonant is N-1,3-Dimethylbutyl-N′-phenyl-p-phenylenediamine, a microcrystalline paraffin blend, and combinations thereof.

The following examples illustrate the various embodiments of the present invention. Those skilled in the art will recognize many variations that are within the spirit of the present invention and scope of the claims.

Table 1 provides an exemplary base composition for a tire tread. Tables 2, 3, and 4 provide examples 1-3 of complete tread compositions using the tread additive compositions set forth above. Table 5 provides example 4 which is a that includes polybutadiene rubber, natural rubber, and a solution styrene-butadiene rubber. It should be appreciated that these compositions can be formulated with values that are plus and minus 20 percent of the indicated values.

TABLE 1
Base Composition for a tire tread.

| Material | LRR1 (PHR) | Category |
|---|---|---|
| First SSBR | 68.75 | Polymer |
| Second SSBR | 50 | Polymer |
| Carbon Black | 5 | Filler |
| Silica | 77 | Filler |
| Treated Distillate Aromatic | 8.9 | Plasticizer |
| Extracted (TDAE) | | |
| Bi-functional disulfide | 6.9 | Coupling |
| organosilane | | agent |
| Stearic Acid | 1.5 | Activator |
| Zinc Oxide | 1.9 | Activator |
| Microcrystalline/paraffin blend | 2 | Wax, |
| | | Antiozonant |
| N-1,3-Dimethylbutyl-N′- | 2 | Antiozonant |
| phenyl-p-phenylenediamine | | |
| Sulfur | 1.05 | Curative |
| N-cyclohexyl-2- | 0.91 | Accelerator |
| benzothioazole sulfenamide | | |
| Diphenyl Guanidine | 1.05 | Accelerator |
| TOTAL | 226.96 | |

TABLE 2
Example 1.

| | wt % | wt % | PHR | Category |
|---|---|---|---|---|
| Base Composition | 39.85 | | | |
| SSBR | | 12.22 | 18.55 | Polymer |
| SSBR | | 8.90 | 13.49 | Polymer |
| Carbon Black | | 0.89 | 1.35 | Filler |
| Silica | | 13.69 | 20.78 | Filler |
| Treated Distillate Aromatic Extracted | | 1.58 | 2.39 | Plasticizer |
| Bi-functional disulfide organosilane | | 1.23 | 1.86 | Coupling agent |
| Stearic Acid | | 0.27 | 0.40 | Activator |
| Zinc Oxide | | 0.34 | 0.51 | Activator |
| Microcrystalline/paraffin blend | | 0.36 | 0.54 | Wax |
| N-1,3-Dimethylbutyl-N′- | | 0.36 | 0.54 | Antiozonant |
| phenyl-p-phenylenediamine | | | | |
| Elastomeric Component Reaction Blend | 39.85 | | | |
| Olefin Block Copolymer | | 38.64 | 58.61 | Polymer |
| Vinyltrimethoxysilane | | 1.11 | 1.68 | Silane |
| 2,5-Dimethyl-2,5-di- | | 0.06 | 0.09 | Peroxide |
| (tert-butylperoxy)-hexane | | | | |
| 1,3,5-Trimethyl-2,4,6-tris(3,5-di-tert- | | 0.01 | 0.01 | Antioxidant |
| butyl-4-hydroxybenzyl)benzene | | | | |
| Linear, non-reactive polydimethylsiloxane | | 0.02 | 0.04 | Silicone |
| First additive Component | 9.12 | | | |
| Ethylene Vinyl Acetate | | 5.14 | 7.79 | Polymer |
| Silica | | 2.57 | 3.89 | Filler |
| Silane-terminated liquid polybutadienes | | 1.28 | 1.95 | Liquid Polymer |
| Octadecanoic acid | | 0.08 | 0.12 | Activator/ |
| | | | | Process Aid |
| Polyethylene glycol | | 0.05 | 0.08 | Activator/ |
| | | | | Process Aid |
| Second additive component | 11.18 | | | |
| LSBR | | 4.37 | 6.63 | Liquid Polymer |
| Resin | | 4.50 | 6.82 | Hydrocarbon |
| | | | | Resin |
| 2,5-Bis(tert-butylperoxy)-2,5- | | 1.68 | 2.54 | Peroxide |
| dimethylhexane | | | | |
| Sulfur (80% active) | | 0.26 | 0.39 | Curative |
| N-cyclohexyl-2- | | 0.18 | 0.27 | Accelerator |
| benzothioazole sulfenamide | | | | |
| Diphenyl Guanidine | | 0.21 | 0.31 | Accelerator |
| Total | 100.00 | 100.00 | 151.63 | |

TABLE 3
Example 2. 1504-6040

| | wt % | wt % | PHR | Category |
|---|---|---|---|---|
| Base Composition | 48.88 | | | |
| SSBR | | 15.01 | 24.18 | Polymer |
| SSBR | | 10.91 | 17.58 | Polymer |
| Carbon Black | | 1.09 | 1.76 | Filler |
| Silica | | 16.81 | 27.08 | Filler |
| Treated Distillate Aromatic Extracted | | 1.93 | 3.12 | Plasticizer |
| Bi-functional disulfide organosilane | | 1.51 | 2.43 | Coupling agent |
| Stearic Acid | | 0.33 | 0.53 | Activator |
| Zinc Oxide | | 0.41 | 0.67 | Activator |
| Microcrystalline/paraffin blend | | 0.44 | 0.70 | Wax |
| N-1,3-Dimethylbutyl-N′- | | 0.44 | 0.70 | Antiozonant |
| phenyl-p-phenylenediamine | | | | |
| Elastomeric Component Reaction Blend | 32.56 | | | |
| Olefin Block Copolymer | | 31.58 | 50.88 | Polymer |
| Vinyltrimethoxysilane | | 0.90 | 1.46 | Silane |
| 2,5-Dimethyl-2,5-di- | | 0.05 | 0.08 | Peroxide |
| (tert-butylperoxy)-hexane | | | | |
| 1,3,5-Trimethyl-2,4,6-tris(3,5-di-tert- | | 0.00 | 0.01 | Antioxidant |
| butyl-4-hydroxybenzyl)benzene | | | | |
| Linear, non-reactive polydimethylsiloxane | | 0.02 | 0.03 | Silicone |
| First additive Component | 7.44 | | | |
| Ethylene Vinyl Acetate | | 4.20 | 6.76 | Polymer |
| Silica | | 2.10 | 3.38 | Filler |
| Silane-terminated liquid polybutadienes | | 1.05 | 1.69 | Liquid Polymer |
| Octadecanoic acid | | 0.06 | 0.10 | Activator/ |
| | | | | Process Aid |
| Polyethylene glycol | | 0.04 | 0.07 | Activator/ |
| | | | | Process Aid |
| Second additive component | 11.12 | | | |
| LSBR | | 4.47 | 7.20 | Liquid Polymer |
| Chemical or CAS Proprietary | | 4.50 | 7.25 | Hydrocarbon |
| | | | | Resin |
| 2,5-Bis(tert-butylperoxy)-2,5- | | 1.37 | 2.21 | Peroxide |
| dimethylhexane | | | | |
| Sulfur (80% active) | | 0.31 | 0.51 | Curative |
| N-cyclohexyl-2- | | 0.22 | 0.35 | Accelerator |
| benzothioazole sulfenamide | | | | |
| Diphenyl Guanidine | | 0.25 | 0.40 | Accelerator |
| Total | 100.00 | 100.00 | 161.13 | |

TABLE 4
Example 3

| | | wt % | PHR | Category |
|---|---|---|---|---|
| Base Composition | 41.45 | | | |
| SSBR | | 12.73 | 18.45 | Polymer |
| SSBR | | 9.26 | 13.42 | Polymer |
| Carbon Black | | 0.92 | 1.34 | Filler |
| Silica | | 14.25 | 20.67 | Filler |
| Treated Distillate Aromatic Extracted | | 1.64 | 2.38 | Plasticizer |
| Bi-functional disulfide organosilane | | 1.28 | 1.85 | Coupling agent |
| Stearic Acid | | 0.28 | 0.40 | Activator |
| Zinc Oxide | | 0.35 | 0.51 | Activator |
| Microcrystalline/paraffin blend | | 0.37 | 0.54 | Wax |
| N-1,3-Dimethylbutyl-N′- | | 0.37 | 0.54 | Antiozonant |
| phenyl-p-phenylenediamine | | | | |
| Elastomeric Component Reaction Blend | 41.46 | | | |
| Olefin Block Copolymer | | 40.22 | 58.31 | Polymer |
| Vinyltrimethoxysilane | | 1.15 | 1.67 | Silane |
| 2,5-Dimethyl-2,5-di- | | 0.06 | 0.09 | Peroxide |
| (tert-butylperoxy)-hexane | | | | |
| 1,3,5-Trimethyl-2,4,6-tris(3,5-di-tert- | | 0.01 | 0.01 | Antioxidant |
| butyl-4-hydroxybenzyl)benzene | | | | |
| Linear, non-reactive polydimethylsiloxane | | 0.02 | 0.04 | Silicone |
| First additive Component | 10.01 | | | |
| Ethylene Vinyl Acetate | | 5.64 | 8.18 | Polymer |
| Silica | | 2.82 | 4.09 | Filler |
| Silane-terminated liquid polybutadienes | | 1.41 | 2.04 | Liquid Polymer |
| Octadecanoic acid | | 0.08 | 0.12 | Activator/ |
| | | | | Process Aid |
| Polyethylene glycol | | 0.06 | 0.08 | Activator/ |
| | | | | Process Aid |
| Second additive Component | 7.08 | | | |
| Polybutadiene Rubber | | 4.60 | 6.67 | Polymer |
| 2,5-Bis(tert-butylperoxy)-2,5- | | 1.84 | 2.67 | Peroxide |
| dimethylhexane | | | | |
| Sulfur (80% active) | | 0.26 | 0.37 | Curative |
| N-cyclohexyl-2- | | 0.18 | 0.26 | Accelerator |
| benzothioazole sulfenamide | | | | |
| Diphenyl Guanidine | | 0.20 | 0.30 | Accelerator |
| Total | 100.00 | 100.00 | 145.00 | |

TABLE 5
Example 4

| | PHR | Category |
|---|---|---|
| Polybutadiene Rubber | 45.00 | Polymer |
| Natural Rubber | 40.00 | Polymer |
| SSBR | 20.62 | Polymer |
| Silica | 47.00 | Filler |
| Treated Distillate Aromatic Extracted | 6.88 | Plasticizer |
| Bis(triethoxysilylpropyl)polysulfide | 3.76 | Coupling agent |
| Stearic Acid | 1.00 | Activator |
| Zinc Oxide (80% active) | 6.25 | Activator |
| N-1,3-Dimethylbutyl-N′- | 1.50 | Antiozonant |
| phenyl-p-phenylenediamine | | |
| Paraffin Wax | 1.50 | Antiozonant |
| Sulfur (80% active) | 1.96 | Curative |
| N-cyclohexyl-2- | 1.54 | Accelerator |
| benzothioazole sulfenamide | | |
| Diphenyl Guanidine | 1.54 | Accelerator |
| Total | 178.55 | |

The physical properties for Examples 1˜4 are summarized in Table 6. It should be appreciated that values plus and minus 20 percent of the indicated values in Table 6 can be achieved by adjusting the formulations within the ranges set forth above.

TABLE 6
Physical Properties for Examples 1-4.

| | | | | | | | | ASTM | |
|---|---|---|---|---|---|---|---|---|---|
| | | ASTM | | | | | | D395 | DIN |
| | ASTM | D297 | Tensile (ASTM D412, Die C) | | | | ASTM | Method B | Abrasion |
| | D2240 | Specific | | | 50% | 100% | D624 | 22 h/80° C. | (DIN |
| | Shore | Gravity | Tensile | Elongation | Modulus | Modulus | Tear C | Compression | 53516) |
| Group | A | (g/cc) | MPa | % | (Mpa) | (Mpa) | (N/mm) | Set (%) | mm³ |
| Base | 66 | 1.167 | 17.3 | 471 | 1.4 | 2.3 | 35 | 19.8 | 131.6 |
| composition | | | | | | | | | |
| 1 | | | | | | | | | |
| Example 1 | 69 | 1.024 | 12.7 | 338 | 2.2 | 3.6 | 31 | 33 | 135.8 |
| Example 2 | 69 | 1.029 | 13.4 | 362 | 2 | 3.2 | 27.1 | 33.5 | 140.9 |
| Example 3 | 72 | 1.106 | 11 | 261 | 2.5 | 3.9 | 30 | 31.2 | 114.6 |
| Example 3 | 59 | 1.122 | 18.3 | 604 | 1.2 | 2.0 | 68 | — | 54.5 |

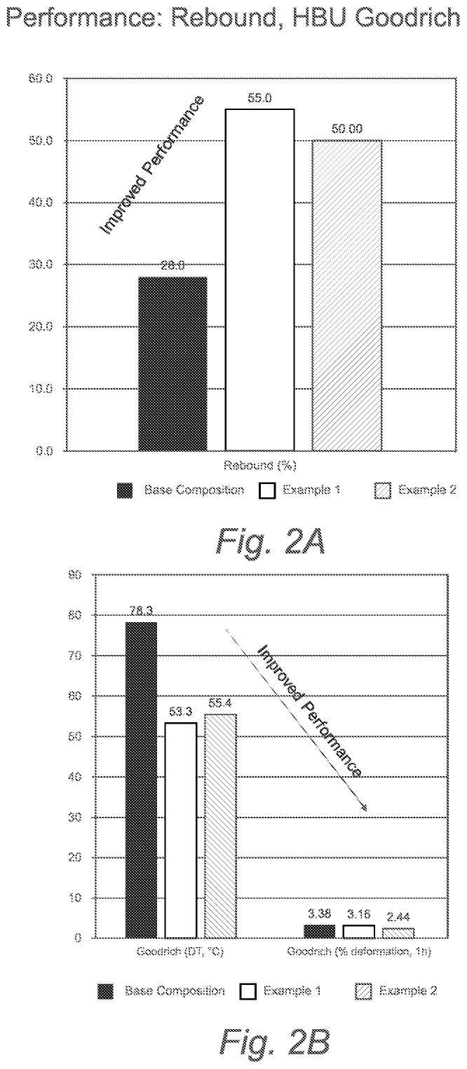

FIG. 2A provides the results of resilience testing. The resilience of the various compounds was tested by using DIN resilience tester (DIN 53512 and ISO 4662) obtained from QMESYS Company Ltd. The hammer of the instrument was allowed to strike the samples (˜6 mm thickness) for about 5 times to eliminate internal defects; the values of the remaining hits were recorded. Three samples were tested for each composition, and their results were averaged. The hammer attached to the pendulum, strikes the 6 mm thick sample and bounces back, and the bounce back is measured as a %, from the height it was dropped. The higher the bounce back, the higher resilience and lower the rolling resistance.

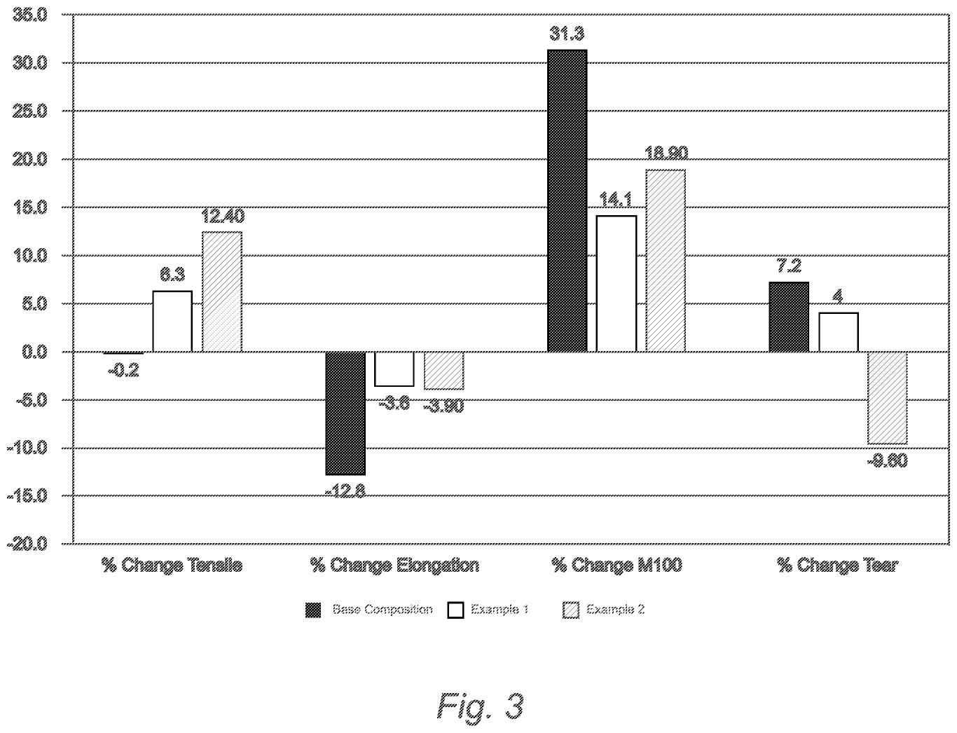

FIG. 2B provides the results of Goodrich Heat build-up experiments. FIG. 3A shows the heat build-up due to repetitive compression/relaxation at high speed to simulate the tire tread going through a contact patch (simulating the running of a tire). The ASTM D623, Method A, test method subjects a cylindrical specimen to rapidly oscillating compressive stresses under controlled conditions. The heat build-up is measured, as well as the permanent (compression) set. The conditions used for these tests were: Base temperature: 100° C. (212° F.) Length of stroke: 4.45 mm (0.175 in) Static load: 244.6 N (55 lbf) Conditioning time: 20 min. Running time: 25 and 60 minutes. A lower temperature rise is better for the tire and is proportional to the resilience and rolling resistance. The samples are taken after the test and measured for the permanent set and again, lower the set is better.

FIG. 3 provides a bar chart showing aging results after aging at 100° C. for 72 hrs. Adding the additives of this invention, improves the heat aging performance of the control compound with higher tensile, minum loss of elongation and minimal gain in modulus, after heat aging. This improvement in heat aging will provide a consistent performance of the tire over a period of time.

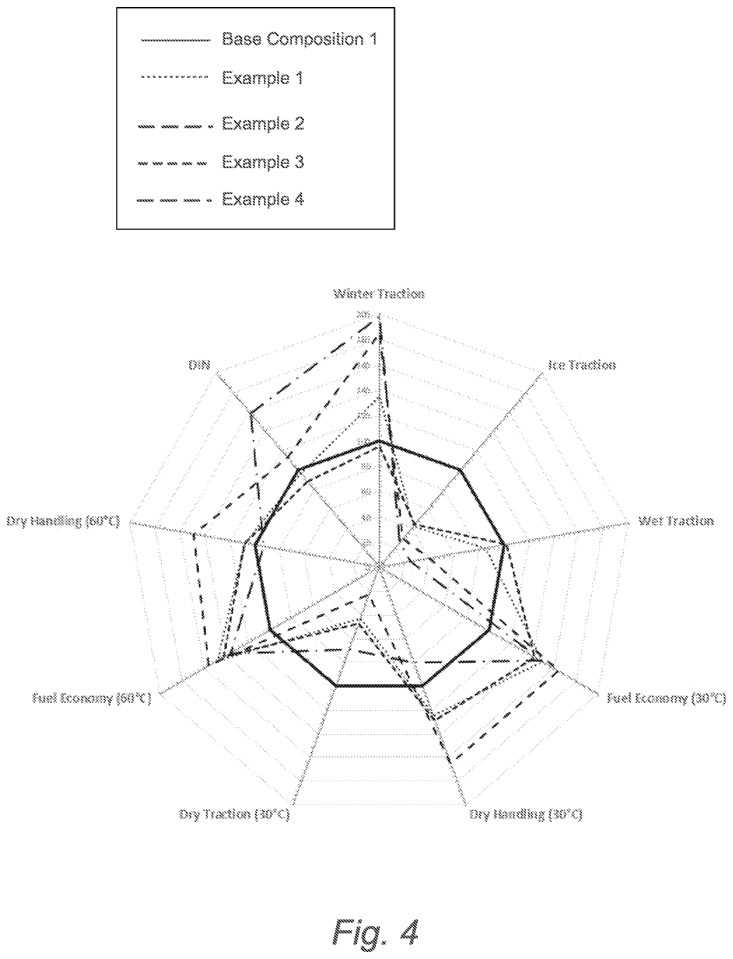

FIG. 4 provides a spider graph summarizing the comparison between Examples 1-4 with base composition 1. In general, examples 1-4 show better fuel economy, winter traction, dry handing, and DIN.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A tread additive composition to be combined with a base composition for tire treads or tank track pads to achieve low rolling resistance, the tread additive composition comprising:
an elastomeric component including first silane grafted polyolefin elastomer and/or silane-grafted styrene-ethylene-butylene-styrene elastomer;
a first additive component including:
a polymer carrier;
a reinforcing filler;
a silane-terminated liquid polybutadiene(s); and
one or more process activators; and
a second additive component including:
a butadiene rubber;
a hydrocarbon resin;
sulfur; and
one or more accelerators.

2. The tread additive composition of claim 1 wherein the first silane grafted polyolefin elastomer is an silane-grafted olefin block copolymer.

3. The tread additive composition of claim 2 wherein the silane-grafted olefin block copolymer has a density less than about 0.9 g/cm³.

4. The tread additive composition of claim 2 wherein the elastomeric component has a glass transition temperature less than −30° C.

5. The tread additive composition of claim 2, wherein the silane-grafted olefin block copolymer has a first melt index less than about 5.

6. The tread additive composition of claim 1, wherein the elastomeric component includes at least one additional silane-grafted polyolefin elastomer.

7. The tread additive composition of claim 6, wherein the first silane-grafted polyolefin elastomer and/or the at least one additional silane grafted polyolefin elastomer is selected from the group consisting of silane-grafted ethylene/α-olefin copolymers, silane-grafted olefin block copolymers, and combinations thereof.

8. The tread additive composition of claim 6 wherein the first silane-grafted polyolefin elastomer and/or the at least one additional silane-grafted polyolefin elastomer is selected from the group consisting of silane-grafted olefin homopolymers, silane-grafted blends of homopolymers, copolymers of two or more olefins, silane-grafted blends of copolymers of two or more olefins, and a combination of silane-grafted olefin homopolymers blended with copolymers of two or more olefins.

9. The tread additive composition of claim 6, wherein the first silane-grafted polyolefin elastomer and/or the at least one additional silane-grafted polyolefin elastomeris include a silane-grafted copolymer of an olefin selected from the group consisting of ethylene, propylene, 1-butene, 1-propene, 1-hexene, 1-octene, C₉₋₁₆ olefins, and combinations thereof.

10. The tread additive composition of claim 6, wherein the first silane grafted polyolefin elastomer and/or the at least one additional silane grafted polyolefin elastomer includes a silane-grafted polymer selected from the group consisting of silane-grafted block copolymers, silane-grafted ethylene propylene diene monomer polymers, silane-grafted ethylene octene copolymers, silane-grafted ethylene butene copolymers, silane-grafted ethylene α-olefin copolymers, silane-grafted 1-butene polymer with ethene, polypropylene homopolymers, silane-grafted methacrylate-butadiene-styrene polymers, silane-grafted polymers with isotactic propylene units with random ethylene distribution, styrenic block copolymers, silane-grafted styrene ethylene butylene styrene copolymer, and combinations thereof.

11. The tread additive composition of claim 1, wherein the silane-graphed polyolefin elastomer is formed form a blend that includes a polyolefin and a silane crosslinker has the following formula 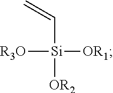
and
R₁, R₂, and R₃ are each independently H or C₁₋₈ alkyl.

12. The tread additive composition of claim 11 wherein R₁, R₂, and R₃ are each methyl, ethyl, propyl, or butyl.

13. The tread additive composition of claim 1, wherein:
the first silane-grafted polyolefin elastomer is present in an amount from about 40 to 85 weight percent of the total weight of the tread additive composition;
the linear, non-reactive polydimethylsiloxane is present in an amount from about 0.005 to 0.3 weight percent of the total weight of the tread additive composition;
the polymer carrier is present in an amount from about 5 to 20 weight percent of the total weight of the tread additive composition;
the reinforcing filler is present in an amount from about 1 to 10 weight percent of the total weight of the tread additive composition;
the butadiene rubber is present in an amount from about 2 to 15 weight percent of the total weight of the tread additive composition; and
sulfur is present in an amount from about 0.1 to 2 weight percent of the total weight of the tread additive composition.

14. The tread additive composition of claim 13, wherein an antioxidant is present in an amount from about 0.001 to 0.3 weight percent of the total weight of the tread additive composition.

15. The tread additive composition of claim 13, wherein the one or more process activators are present in an amount from about 0.01 to 2 weight percent of the total weight of the tread additive composition.

16. The tread additive composition of claim 13, wherein one or more accelerators in an amount from about 0.1 to 2 weight percent of the total weight of the tread additive composition.

17. The tread additive composition of claim 11, wherein the elastomeric component reaction blend includes a first peroxide initiator and the second additive component includes a second peroxide initiator.

18. The tread additive composition of claim 17 wherein the first peroxide initiator and the second peroxide initiator are each independently an organoperoxide.

19. The tread additive composition of claim 17, wherein the first peroxide initiator is present in an amount from about 0.005 to 0.3 weight percent of the total weight of the tread additive composition and the second peroxide initiator is present in an amount from about 0.5 to 7 weight percent of the total weight of the tread additive composition.

20. A tire tread composition for forming tire treads comprising the tread additive composition of claim 1 and a base composition for tire treads.

21. The tire tread composition of claim 20, wherein the tire tread composition includes from about 30 to 63 weight percent of the base composition and about 70 to 37 weight percent of the tread additive composition.

22. Tire treads made by forming the tire tread composition of claim 20 into tire treads and then curing the tire tread composition.
